(19) United States
(12) Patent Application Publication
(10) Pub. No.: US 2010/0181414 A1
(43) Pub. Date: Jul. 22, 2010

(54) Personal transportation vehicle

(76) Inventor: Ignacio Lopez, JR., Mission Viejo, CA (US)

Correspondence Address: Ignacio Lopez Jr., Apt. 57, 24950 Via Florecer, Mission Viejo, CA, 92692, US

(21) Appl. No.: 12/320,136

(22) Filed: Jan. 21, 2009

(51) Int. Cl. B64C 15/12; B64C 29/00

(52) U.S. Cl. 244/12.4

(57) ABSTRACT

This is a Vertical/Short Takeoff and Landing (VSTOL) vehicle for personal transportation of at least one person, to a destination. The four main engine-driven rotors or propellers are pivot-mounted and can be varied in angular position. The main engines are operated by a vector-control system permitting the thrust of the vehicle engines to change from horizontal to vertical and vice versa for takeoff, forward or backwards flight, and landing procedures. This vehicle is also capable of hovering, ascending, and descending during flight. The other four rotors or propellers are mounted at fixed positions, two at the rear, and two at the front, of the vehicle. The vehicle also consists of landing gear of virtually any type.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

This invention relates generally to a personal transportation vehicle and, more particularly, the invention relates to a personal transportation vehicle providing the motoring populace in the U.S. and elsewhere with an alternative mode of personal transportation to avoid the need to drive in increasingly heavy traffic conditions.

2. Description of the Prior Art

If getting stuck in traffic makes you want to roll down your car window and scream, you should make sure your vocal cords are in good shape because gridlock is getting worse. As most motorists already know, traffic congestion has worsened in all parts of the country and more money and hours are wasted in traffic congestion than ever before. According to the Texas Transportation Institute's 2007 Urban Mobility Report, the nation's drivers annually experienced 4.2 billion hours of delay and wasted 2.9 billion gallons of fuel stuck in traffic in 2007. The cost of the nation of this congestion, in 2007 dollars, was an all-time high $78 billion.

The report also finds that more of our roads and highways are suffering from congestion, and longer periods of the day are affected by increasingly worse congestion. The report estimates it took drivers in large urban areas, 30-50 percent more time to get to their destinations during peak travel times than in non-rush periods because of traffic congestion. The main reason that congestion is getting worse is that roads aren't being built fast enough to carry all the people who now drive on them. The number of vehicle miles traveled has increased 77 percent since 1982, but road lane mileage only increased 6 percent.

The American Association of State Highway and Transportation Officials estimated it would take as much as $400 billion in federal spending over the next six years to solve traffic problems but, unfortunately, most transportation experts agree that traffic congestion will never be solved. It will only be kept within limits as the region's population increases, people live farther apart and drive on a road system that is not expanding as required.

### BRIEF SUMMARY OF THE INVENTION

This is a VSTOL personal transportation vehicle designed to transport people to and from their destinations, and as an alternative to driving in traffic-filled streets. Fuel costs and commuting times are kept to a minimum due to no traffic congestion while in flight. This VSTOL vehicle can land on virtually any type of surface, and requires minimum space while grounded. Costs for an air-vehicle infrastructure are significantly less when compared to construction costs for a ground-vehicle infrastructure, over the long-term, and much more flexible in terms of maintenance and future upgrade requirements.

### BRIEF DESCRIPTION OF THE SEVERAL VIEWS OF THE DRAWINGS

FIGS. 1-4 are Perspective views illustrating a personal transportation vehicle, constructed in accordance with the present invention.

FIG. 5 shows the Top view of a VSTOL vehicle. All rotors or propellers and the cockpit are shown.

FIG. 6 shows the Side View of a VSTOL vehicle, with Landing gear fully extended and cockpit shown.

FIG. 7 shows the Rear View of a VSTOL vehicle. Rear section of the vehicle is shown.

FIG. 8 shows the Front View of a VSTOL vehicle. Front section of the vehicle is shown.

FIG. 9 shows the Enlarged Side View of a VSTOL vehicle, with two of the four rotors or propellers in horizontal and vertical positions, respectively.

FIG. 10 shows the Enlarged Side View of a VSTOL vehicle, with two of the four rotors or propellers in different angular positions from one another.

FIGS. 11-13 shows the approximate size differences between the main, front, and rear rotors or propellers.

FIG. 11 is the approximate size of the four main rotors or propellers, in both front and rear sections of the vehicle.

FIG. 12 is the approximate size of the two rear rotors or propellers, at the rear of the vehicle.

FIG. 13 is the approximate size of the two front rotors or propellers, at the front of the vehicle.

### DETAILED DESCRIPTION OF THE INVENTION

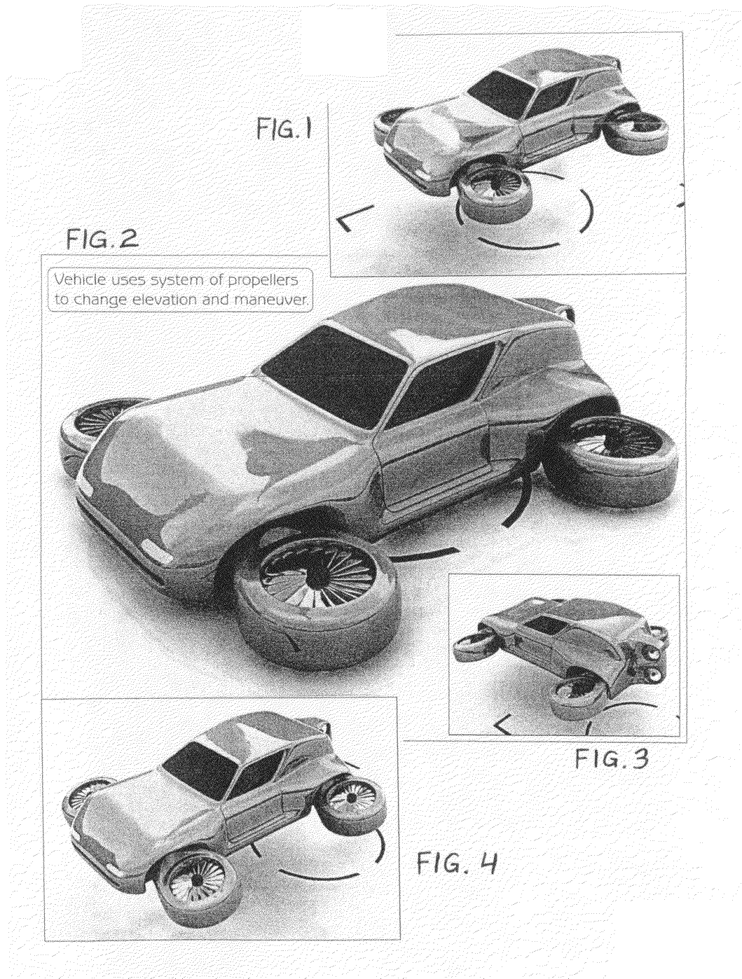

As illustrated in FIGS. 1-4, the present invention is a personal transportation vehicle. The personal transportation vehicle of the present invention is a Vertical/Short Takeoff and Landing (VSTOL) vehicle designed to provide the motoring populace in the U.S. and elsewhere with an alternative mode of personal transportation to avoid the need to drive in increasingly heavy traffic conditions. Four sheets of additional drawings are enclosed and hereby herein incorporated by reference.

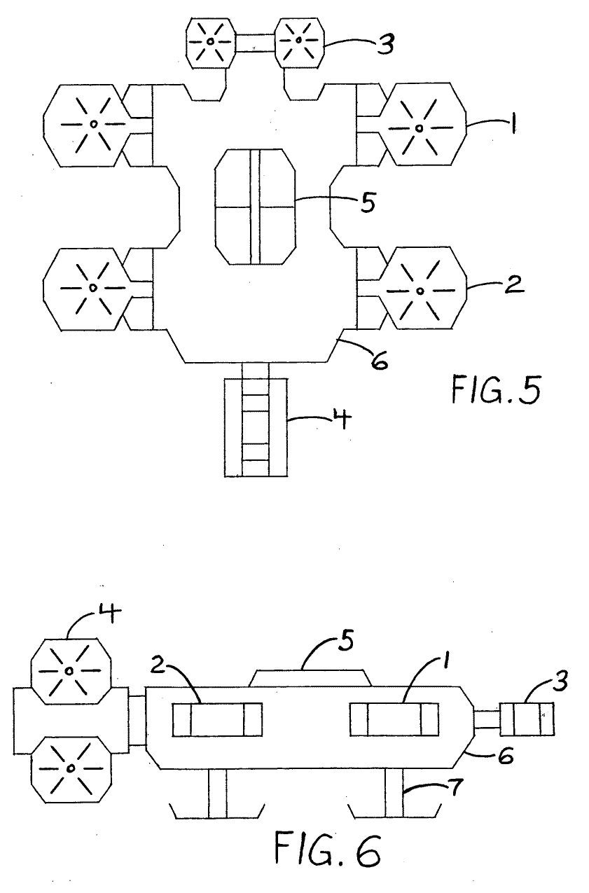

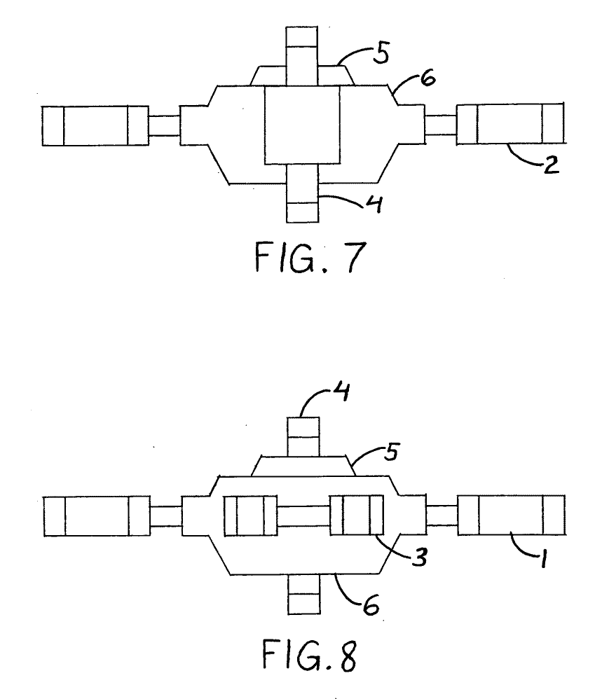

The personal transportation vehicle of the present invention is comparable in size and passenger capacity to conventional automotive vehicles and has approximate dimensions of sixteen (16) feet in length, eight (8) feet in width, and six (6) feet in height. These dimensions take into account the possible sizes of the fuselage 6, all rotors or propellers 1,2,3,4, and the size of the cockpit 5 (FIG. 5).

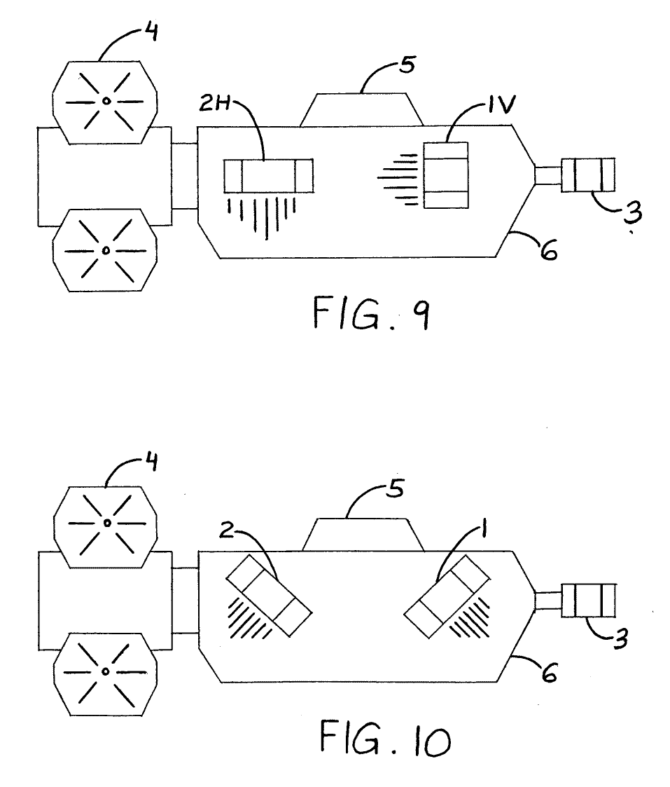

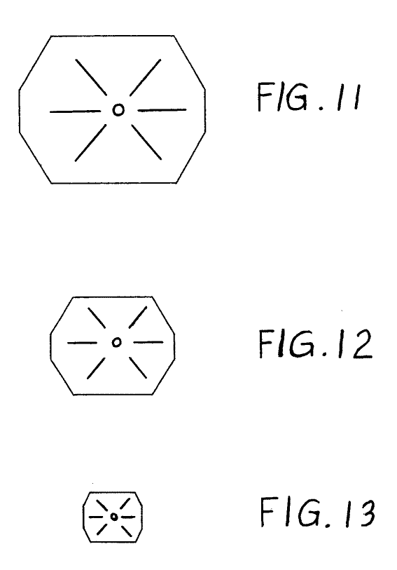

The personal transportation vehicle is equipped with four, engine driven rotors or propellers 1,2 and landing gear of virtually any type 7 (FIG. 6). Two of the four main engines 1 are installed in the front section of the fuselage 6 and two of the four main engines 2 are installed in the rear section of the fuselage 6 (FIG. 5). Each engine is pivot mounted and can be varied in angular position (FIG. 10). The engines are operated by a vector-control system permitting the thrust of the vehicle engines to change from horizontal 2H to vertical 1V and vice versa for takeoffs, forward or backwards flight, and landing procedures (FIG. 9).

The engines of the personal transportation vehicle of the present invention can be varied from a full, vertical position to a full, horizontal position and angular positions in-between the two extremes (FIGS. 9-10). In the fully horizontal position 2H, the vehicle is able to hover, ascend, and descend, in the same manner as a helicopter (FIG. 9). In the fully vertical position 1V, the vehicle operates in the same manner as a fixed wing aircraft (FIG. 9).

In addition to the four main rotors or propellers, the preferred embodiment consists of two smaller rotors or propellers 4 located at the rear of the vehicle (FIG. 6). These rotors or propellers assist in the stability of the vehicle by permitting yaw movement and/or roll assistance as required.

In addition to all other rotors or propellers, the preferred embodiment consists of two smaller rotors or propellers 3 located at the front of the vehicle (FIG. 5). These rotors or propellers assist with pitch and/or roll movements as required.

With the Vertical/Short Takeoff and Landing (VSTOL) capabilities of a helicopter, the personal transportation vehicle of the present invention is able to takeoff and land without a runway, enabling deployment from virtually any location, such as a driveway or parking lot. The vehicle solves a real need for an alternative type of personal transportation making it possible to avoid the increasingly congested highways of the U.S. and elsewhere.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that that the scope of the present invention is to be limited only to the claims except as precluded by the prior art. Moreover, the invention as disclosed herein may be suitably practiced in the absence of the specific elements which are disclosed herein.

What is claimed is:

1. The personal transportation vehicle substantially as described and illustrated herein.

2. All inventions described and illustrated herein.

3. A VSTOL vehicle comprising:
a a cockpit as part of the fuselage and a cargo area within the fuselage;
b a fuselage designed to maintain aerodynamic lift in horizontal or vertical flight and having both longitudinal and transverse axes;
c rotors or propellers which rotate about the longitudinal axis of the rotor or propeller to generate independent streams of airflow for propelling and stabilizing the vehicle;
d rotors or propellers which are pivot-mounted to the fuselage and can be varied in angular position;
e a means to transmit the energy generated by the engines to the rotors or propellers;
f a coordinated system to utilize the energy generated by the engines to stabilize and balance the vehicle and to allow the vehicle to move and rotate in any direction;
g a vector-control system permitting the thrust of the vehicle engines to change from horizontal to vertical and vice versa for takeoffs, flight, and landings;
h engines or power plants capable of generating and maintaining the necessary energy requirements during flight and emergency landings;

4. A VSTOL vehicle as in claim 3, wherein said rotors or propellers are ducted fans.

5. A VSTOL vehicle as in claim 3, wherein said rotors or propellers are not ducted fans.

6. A VSTOL vehicle as in claim 3, wherein the fuselage has at least two lift-producing rotors or propellers attached on each side of the transverse axis;

7. A VSTOL vehicle as in claim 3, wherein the fuselage has additional rotors or propellers which support the main rotors or propellers and further stabilize the vehicle;

8. A VSTOL vehicle as in claim 3, comprising of a means to generate and maintain high levels of angular momentum whereby the vehicle is stabilized by the gyroscopic effect;

9. A VSTOL vehicle as in claim 3, wherein the lift-producing rotors or propellers counter-rotate in relation to one another in order to compensate for and overcome the gyroscopic effect;

10. A VSTOL vehicle as in claim 3, wherein rotors or propellers and engines generate high levels of kinetic energy whereby the vehicle can utilize the generated energy to assist during takeoffs, flight, and landings.

11. A VSTOL vehicle as in claim 3, wherein the fuselage of this vehicle is shaped to utilize the ground effect during takeoffs, landings, and when hovering above land and water surfaces.

12. A VSTOL vehicle as in claim 3, wherein the vehicle has interchangeable landing gear, thereby allowing this vehicle to land on and takeoff from virtually any water or land surface.
